(19) United States
(12) Patent Application Publication
(10) Pub. No.: US 2010/0104794 A1
(43) Pub. Date: Apr. 29, 2010

(54) THERMOSETTING EPOXY RESIN COMPOSITION AND SEMICONDUCTOR DEVICE

(75) Inventors: Takayuki Aoki, Gunma (JP); Toshio Shiobara, Gunma (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Shin-Etsu Chemical Co., Ltd., Chiyoda-ku (JP)

(21) Appl. No.: 11/997,831

(22) PCT Filed: Jul. 28, 2006
(86) PCT No.: PCT/JP2006/314971

§ 371 Date: Feb. 4, 2008

(30) Foreign Application Priority Data
Aug. 4, 2005 (JP) 2005-226236

(51) Int. Cl. B32B 1/06; C08L 63/10; C08G 69/00; C08G 59/20

(52) U.S. Cl. 428/76; 523/458; 528/327; 528/313; 528/317; 528/314

(57) ABSTRACT

A thermosetting epoxy resin composition characterized by containing as a resin ingredient a product of pulverization of a solid matter obtained by reacting a triazine derivative/epoxy resin with an acid anhydride in such a proportion that the amount of the epoxy groups is 0.6-2.0 equivalents to the acid anhydride groups.

### TECHNICAL FIELD

This invention relates to thermosetting epoxy resin compositions having an excellent curability and imparting cured products which have improved heat resistance, light resistance, strength, resistance to thermal discoloration, especially yellowing, and reliability; and semiconductor devices wherein semiconductor members such as photodetectors and the like (exclusive of light emitting members like LED's but inclusive of photocouplers in which a light emitting devices and a photodetector are integrated) are encapsulated with the cured compositions.

### BACKGROUND ART

The reliability demand on encapsulants for semiconductor and electronic devices becomes more stringent as the devices are reduced in size and profile and increased in output. For example, semiconductor members such as light emitting diodes (LED) and laser diodes (LD) have many advantages including small size, vivid color light emission, elimination of bulb failure, excellent drive characteristics, resistance to vibration, and resistance to repeated turn-on and off. These semiconductor members are often utilized as various indicators and light sources.

At the present, polyphthalamide (PPA) resins are widely used as one class of encapsulating material for semiconductor and electronic devices using such semiconductor members, for example, photocouplers.

The current rapid advance of the photo-semiconductor technology has brought about photo-semiconductor devices of increased output and shorter wavelength. Photo-semiconductor devices such as photocouplers capable of transmitting or receiving high-energy light are often encapsulated or encased using prior art PPA resins as colorless or white material. However, these encapsulants and casings are substantially degraded during long-term service and susceptible to visible color variations, separation and a lowering of mechanical strength. It is desired to overcome these problems effectively.

More particularly, Japanese Patent No. 2,656,336 (Patent Document 1) discloses that a photo-semiconductor device is encapsulated with a B-staged epoxy resin composition, in the cured state, comprising an epoxy resin, a curing agent, and a cure promoter, the components being uniformly mixed on a molecular level. Allegedly, this epoxy resin composition is advantageously used as an encapsulating material for optical pickups in compact disc players or for solid-state image pickup devices such as line sensors and area sensors. Using such photo-semiconductor encapsulating epoxy resin compositions, photodetectors such as solid-state image pickups are encapsulated. The resulting photo-semiconductor packages are improved in performance because they form images in which neither fringes due to optical variations of the resin nor black peppers due to foreign particles in the resin appear. The performance of these packages, albeit resin encapsulation, is at least comparable to ceramic packages. As to the epoxy resin, it is described that bisphenol A epoxy resins or bisphenol F epoxy resins are mainly used although triglycidyl isocyanate and the like may also be used. In examples, triglycidyl isocyanate is added in a minor amount to the bisphenol epoxy resin. The present inventors have empirically found that this B-staged epoxy resin composition for semiconductor encapsulation tends to yellow when held at high temperatures for a long period of time.

Triazine derived epoxy resins are used in light-emitting member-encapsulating epoxy resin compositions as disclosed in JP-A 2000-196151 (Patent Document 2), JP-A 2003-224305 (Patent Document 3), and JP-A 2005-306952 (Patent Document 4). None of these patents suggest the reaction product of a triazine derived epoxy resin and an acid anhydride.

The documents including the above documents pertinent to the present invention are listed below.
Patent Document 1: Japanese Patent No. 2,656,336
Patent Document 2: JP-A 2000-196151
Patent Document 3: JP-A 2003-224305
Patent Document 4: JP-A 2005-306952
Patent Document 5: Japanese Patent No. 3,512,732
Patent Document 6: JP-A 2001-234032
Patent Document 7: JP-A 2002-302533
Non-Patent Document 1: Electronics Packaging Technology, April 2004.

### DISCLOSURE OF THE INVENTION

### Problem to Be Solved by the Invention

The present invention has been done in view of the above circumstances. An object of the invention is to provide thermosetting epoxy resin compositions which cure into uniform products capable of maintaining heat resistance and light resistance over a long period of time without substantial yellowing; and semiconductor devices wherein semiconductor members (exclusive of light emitting members like LED's but inclusive of photocouplers in which a light emitting devices and a photodetector are integrated) are encapsulated with the cured compositions.

### Means for Solving the Problem

The inventors have earnestly studied in order to attain the above object. As a result, it has been found that a thermosetting epoxy resin composition is arrived at by using a triazine derived epoxy resin as a sole epoxy resin, reacting the triazine derived epoxy resin with an acid anhydride in an epoxy group equivalent to acid anhydride group equivalent ratio of 0.6-2.0:1, preferably in the presence of an antioxidant and/or curing catalyst, to form a solid reaction product, grinding the solid reaction product, and formulating the ground solid as a resin component; and that this composition is effectively curable and cures into a product having improved heat resistance, light resistance, and strength.

Accordingly, the invention provides a thermosetting epoxy resin composition and a semiconductor device as defined below.

[I] A thermosetting epoxy resin composition comprising as a resin component a solid reaction product obtained through reaction of a triazine derived epoxy resin with an acid anhydride in an epoxy group equivalent to acid anhydride group equivalent ratio of 0.6:1 to 2.0:1, the solid reaction product being ground.
[II] The epoxy resin composition of [I] wherein the triazine derived epoxy resin is a 1,3,5-triazine nucleus derived epoxy resin.
[III] The epoxy resin composition of [II] wherein the solid reaction product comprises a compound having the general formula (1):

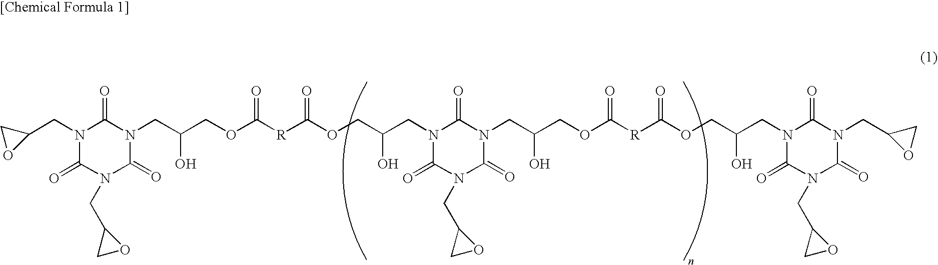

wherein R is an acid anhydride residue and n is a number of 0 to 200.
[IV] The epoxy resin composition of [I], [II] or [III] wherein the acid anhydride is non-aromatic and free of a carbon-to-carbon double bond.
[V] The epoxy resin composition of any one of [I] to [IV] wherein the reaction of a triazine derived epoxy resin with an acid anhydride is carried out in the presence of an antioxidant.
[VI] The epoxy resin composition of [V] wherein the antioxidant is selected from the group consisting of phenolic, phosphorus-based and sulfur-based antioxidants, and mixtures thereof.
[VII] The epoxy resin composition of [VI] wherein the antioxidant comprises triphenyl phosphite and/or 2,6-di-t-butyl-p-cresol.
[VIII] The epoxy resin composition of any one of [I] to [VII] wherein the reaction of a triazine derived epoxy resin with an acid anhydride is carried out at a temperature of 70 to 120° C.
[IX] The epoxy resin composition of any one of [I] to
[VII] wherein the reaction of a triazine derived epoxy resin with an acid anhydride is carried out in the presence of a curing catalyst.
[X] The epoxy resin composition of [IX] wherein the curing catalyst is 2-ethyl-4-methylimidazole.
[XI] The epoxy resin composition of [IX] wherein the curing catalyst is methyltributylphosphonium dimethylphosphite or a quaternary phosphonium bromide.
[XII] The epoxy resin composition of [IX], [X] or [XI] wherein the reaction of a triazine derived epoxy resin with an acid anhydride is carried out at a temperature of 30 to 80° C.
[XIII] The epoxy resin composition of any one of [I] to [XII], further comprising titanium dioxide.
[XIV] The epoxy resin composition of any one of [I] to [XIII], further comprising an inorganic filler other than titanium dioxide.
[XV] The epoxy resin composition of any one of [I] to [XII], which is transparent.
[XVI] The epoxy resin composition of any one of [I] to [XV], which is used to form a casing for semiconductor members excluding light emitting members.
[XVII] A semiconductor device comprising a semiconductor member excluding light emitting members, which is encapsulated with the epoxy resin composition of any one of [I] to [XV] in the cured state.

### BENEFITS OF THE INVENTION

The thermosetting epoxy resin compositions of the invention are effectively curable and cure into uniform products that have satisfactory strength and are capable of maintaining heat resistance and light resistance over a long period of time without substantial yellowing. Then semiconductor and electronic devices having photodetectors such as photocouplers which are encapsulated with the cured compositions are of great worth in the industry.

### BRIEF DESCRIPTION OF THE DRAWING

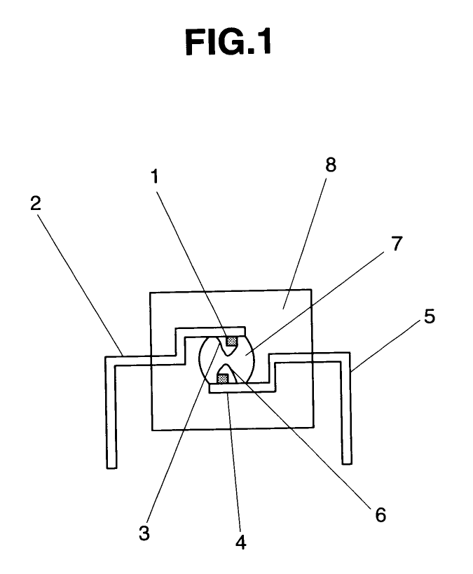

The only figure, FIG. 1 is a cross-sectional view of a photocoupler encapsulated with a thermosetting epoxy resin composition of the invention.

### BEST MODE FOR CARRYING OUT THE INVENTION

### Solid Reaction Product

The thermosetting epoxy resin composition of the invention uses as a resin component a solid reaction product which is obtained by mixing (A) a triazine derived epoxy resin with (B) an acid anhydride in a ratio of epoxy group equivalent to acid anhydride group equivalent of 0.6:1 to 2.0:1, and reacting them, preferably in the presence of (C) an antioxidant and/or (D) a curing catalyst, optionally cooling the reaction product, and grinding the solid reaction product.

### (A) Triazine Derived Epoxy Resin

The triazine derived epoxy resin (A) used herein is such that when a solid reaction product obtained through reaction thereof with an acid anhydride in a specific proportion is ground and formulated as a resin component, the resulting thermosetting epoxy resin composition undergoes little yellowing and is thus suitable for encapsulation to fabricate a semiconductor device which is subject to little degradation with time. The preferred triazine derived epoxy resin include 1,3,5-triazine nucleus derived epoxy resins. Epoxy resins having isocyanurate rings have better light resistance and electrical insulation, with those having a divalent, and more preferably trivalent, epoxy group on one isocyanurate ring being desirable. Useful examples include tris(2,3-epoxypropyl)isocyanurate, tris(α-methylglycidyl)isocyanurate, and tris(α-methylglycidyl)isocyanurate.

The triazine derived epoxy resins used herein preferably have a softening point of 90 to 125° C. It is noted that the triazine derived epoxy resins used herein exclude hydrogenated triazine rings.

### (B) Acid Anhydride

The acid anhydride (B) used herein serves as a curing agent. For light resistance, acid anhydrides which are non-aromatic and free of a carbon-to-carbon double bond are preferred. Examples include hexahydrophthalic anhydride, methylhexahydrophthalic anhydride, trialkyltetrahydrophthalic anhydrides, and hydrogenated methylnadic anhydride, with methylhexahydrophthalic anhydride being most preferred. These acid anhydrides may be used alone or in admixture.

The acid anhydride is used in such amounts that 0.6 to 2.0 equivalents, preferably 1.0 to 2.0 equivalents, more preferably 1.2 to 1.6 equivalents of acid anhydride groups are available per equivalent of epoxy groups in the triazine derived epoxy resin (A). Less than 0.6 equivalent of acid anhydride groups may lead to under-cure and lower reliability. With more than 2.0 equivalents of acid anhydride groups, the unreacted curing agent may be left in the cured composition, detracting from the moisture resistance thereof.

### (C) Antioxidant

The antioxidant (C) used in the epoxy resin composition of the invention is typically selected from among phenolic, phosphorus-based and sulfur-based antioxidants.

Examples of suitable phenolic antioxidants include 2,6-di-t-butyl-p-cresol, butylated hydroxyanisole, 2,6-di-t-butyl-p-ethylphenol, stearyl-β-(3,5-di-t-butyl-4-hydroxyphenyl)propionate, 2,2′-methylenebis(4-methyl-6-t-butylphenol), 4,4′-butylidene bis(3-methyl-6-t-butylphenol), 3,9-bis[1,1-dimethyl-2-{β-(3-t-butyl-4-hydroxy-5-methyl-phenyl)propionyloxy}ethyl]-2,4,8,10-tetraoxaspiro[5,5]-undecane, 1,1,3-tris(2-methyl-4-hydroxy-5-t-butylphenyl)butane, and 1,3,5-trimethyl-2,4,6-tris(3,5-di-t-butyl-4-hydroxy-benzyl)benzene. Inter alia, 2,6-di-t-butyl-p-cresol is preferred.

Examples of suitable phosphorus-based antioxidants include triphenyl phosphite, diphenylalkyl phosphites, phenyldialkyl phosphites, tri(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, di(2,4-di-tert-butylphenyl) pentaerythritol diphosphite, tristearyl sorbitol triphosphite, and tetrakis(2,4-di-tert-butylphenyl)-4,4′-biphenyl diphosphonate. Inter alia, triphenyl phosphite is preferred.

Examples of suitable sulfur-based antioxidants include dilauryl 3,3′-thiodipropionate, dimyristyl 3,3′-thiodipropionate, and distearyl 3,3′-thiodipropionate.

These antioxidants may be used alone or in admixture. It is especially preferred to use a phosphorus-based antioxidant alone or in combination with a phenolic antioxidant. When a mixture of a phenolic antioxidant and a phosphorus-based antioxidant is used, the phenolic antioxidant and the phosphorus-based antioxidant are preferably mixed in a weight ratio from 0:100 to 70:30, more preferably from 0:100 to 50:50.

The antioxidant is preferably used in an amount of 0.01 to 10 parts by weight, more preferably 0.03 to 5 parts by weight per 100 parts by weight of the epoxy resin composition. Outside the range, less amounts of the antioxidant may provide epoxy resin compositions which are less heat resistant or susceptible to discoloration whereas too much amounts may interfere with the cure, inviting losses of cure and strength.

### (D) Curing Catalyst

The curing catalyst (D) used herein may be any of well-known curing catalysts commonly used in epoxy resin compositions of this type. Suitable catalysts include tertiary amines, imidazoles, organic carboxylic acid salts of amines and imidazoles, metal salts of organic carboxylic acids, metal-organic compound chelates, aromatic sulfonium salts, phosphorus-based catalysts such as organic phosphine compounds and phosphonium compounds, and salts of the foregoing, which may be used alone or in admixture. Of these, the imidazoles and phosphorus-based catalysts are preferred. More preferred are 2-ethyl-4-methylimidazole and methyltributylphosphonium dimethylphosphate, and quaternary phosphonium bromides.

The curing catalyst is preferably used in an amount of 0.05 to 5%, more preferably 0.1 to 2% by weight based on the entire composition. Outside the range, the resulting epoxy resin composition may have an undesired profile of heat resistance and moisture resistance.

In the practice of the invention, components (A) and (B), preferably components (A), (B) and (C) are previously heated for reaction at a temperature of 70 to 120° C., preferably 80 to 110° C., for 4 to 20 hours, preferably 6 to 15 hours, or components (A), (B) and (D), preferably components (A), (B), (C) and (D) are previously heated for reaction at a temperature of 30 to 80° C., preferably 40 to 60° C., for 10 to 72 hours, preferably 36 to 60 hours, forming a solid reaction product having a softening point of 50 to 100° C., preferably 60 to 90° C. The solid reaction product is then ground before formulating. A reaction product having a softening point of less than 50° C. does not become solid whereas a reaction product having a softening point of higher than 100° C. may lose fluidity.

Too short a reaction time may yield a reaction product which does not become solid due to less contents of high molecular weight fractions whereas too long a reaction time may detract from fluidity.

The solid reaction product obtained herein, that is, the reaction product of triazine derived epoxy resin (A) and acid anhydride (B) is preferably such that when the reaction product is analyzed by gel permeation chromatography (GPC) under conditions including a sample concentration 0.2 wt %, a feed volume 50 μl, a mobile phase THF 100%, a flow rate 1.0 ml/min, a temperature 40° C., and a detector R1, it contains 20 to 70% by weight of a high molecular weight fraction with a weight average molecular weight of more than 1,500, 10 to 60% by weight of a moderate molecular weight fraction with a weight average molecular weight of 300-1,500, and 10 to 40% by weight of a monomeric fraction.

The solid reaction product contains a compound having the formula (1) when component (A) used is triglycidyl isocyanate, and more specifically, a compound having the formula (2) when component (A) used is triglycidyl isocyanate and component (B) used is methylhexahydrophthalic anhydride.

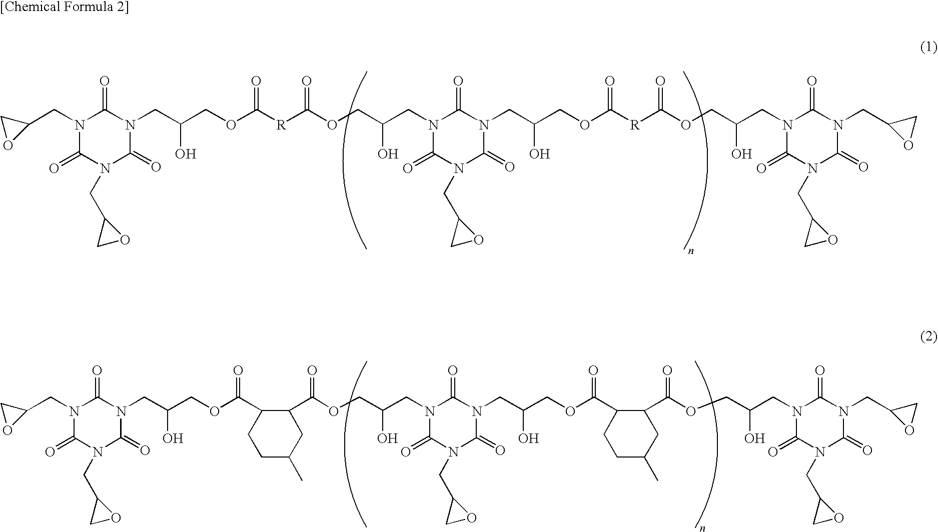

In the above formulae, R is an acid anhydride residue and n is a number of 0 to 200. These compounds have an average molecular weight of 500 to 100,000. Preferably the solid reaction product contains 20 to 70%, especially 30 to 60% by weight of a high molecular weight fraction with a molecular weight of more than 1,500, 10 to 60%, especially 10 to 40% by weight of a moderate molecular weight fraction with a molecular weight of 300-1,500, and 10 to 40%, especially 15 to 30% by weight of a monomeric fraction (unreacted epoxy resin and acid anhydride).

The epoxy resin composition of the invention comprises the solid reaction product as a resin component. In the event the antioxidant (C) and the curing catalyst (D) are not used at the reaction stage of preparing the resin component, preferably the antioxidant (C) and the curing catalyst (D) are incorporated at the later stage of formulating the epoxy resin composition.

In the epoxy resin composition of the invention, additional components may be incorporated as described below.

### (E) Titanium Dioxide

In the epoxy resin composition, (E) titanium dioxide may be incorporated as a white colorant for increasing the whiteness. The unit lattice of titanium dioxide may be either the rutile or anatase type. Its average particle size and shape are not particularly limited. The titanium dioxide may be previously surface treated with hydrous oxides of Al, Si or the like for enhancing the compatibility with and dispersion in the resin and inorganic filler (to be described later).

If used, the titanium dioxide is preferably added in an amount of 2 to 80%, more preferably 5 to 50% by weight based on the entire composition. Less than 2 wt % of titanium dioxide may fail to provide satisfactory whiteness whereas more than 80 wt % may interfere with molding and leave unfilled voids.

An additional white colorant such as potassium titanate, zirconium oxide, zinc sulfide, zinc oxide or magnesium oxide may be used in combination with titanium dioxide. The average particle size and shape of additional colorant are not particularly limited.

### (F) Inorganic Filler

In the epoxy resin composition, (F) an inorganic filler may be incorporated. The inorganic fillers include those commonly used in ordinary epoxy resin compositions, but exclude the titanium dioxide (E). Examples include silicas such as fused silica and crystalline silica, alumina, silicon nitride, aluminum nitride, boron nitride, glass fibers, and antimony trioxide. The average particle size and shape of inorganic fillers are not particularly limited.

The inorganic filler may be previously surface treated with coupling agents such as silane and titanate coupling agents for increasing the bond strength between the resin and the filler before incorporating into the composition.

Suitable coupling agents include epoxy-functional alkoxysilanes such as γ-glycidoxypropyltrimethoxysilane, γ-glycidoxypropylmethyldiethoxysilane, and β-(3,4-epoxycyclohexyl)ethyltrimethoxysilane; amino-functional alkoxysilanes such as N-β-(aminoethyl)-γ-aminopropyltrimethoxysilane, γ-aminopropyltriethoxysilane and N-phenyl-γ-aminopropyltrimethoxysilane; and mercapto-functional alkoxysilanes such as γ-mercaptopropyltrimethoxysilane. No particular limits are imposed on the amount of coupling agent and the technique of surface treatment.

If used, the amount of the inorganic filler loaded is preferably 20 to 700 parts, more preferably 50 to 400 parts by weight per 100 parts by weight of the epoxy resin (A) and the acid anhydride (B) combined. Less than 20 pbw of the filler may fail to provide a satisfactory strength whereas more than 700 pbw may cause a viscosity buildup which causes unfilled defectives and flexibility loss, resulting in such failures as delamination within the encapsulated device. Differently stated, the inorganic filler is preferably used in an amount of 10 to 90%, more preferably 20 to 80% by weight based on the entire composition.

### (G) Other Epoxy Resins

If necessary, epoxy resins other than component (A) may be used in a certain amount as long as the objects of the invention are not compromised. Suitable other epoxy resins include bisphenol A epoxy resins, bisphenol F epoxy resins, biphenol type epoxy resins such as 3,3′,5,5′-tetramethyl-4,4′-biphenol epoxy resins and 4,4′-biphenol epoxy resins, phenol novolac type epoxy resins, cresol novolac type epoxy resins, bisphenol A novolac type epoxy resins, naphthalene diol epoxy resins, trisphenylol methane epoxy resins, tetrakisphenylol ethane epoxy resins, and phenol dicyclopentadiene novolac type epoxy resins in which aromatic rings are hydrogenated.

The other epoxy resins should preferably have a softening point of 70 to 100° C.

### Other Additives

Various other additives may be incorporated in the epoxy resin composition of the invention if necessary. For example, stress-reducing agents such as thermoplastic resins, thermoplastic elastomers, organic synthetic rubbers and silicones, waxes, halogen-trapping agents, and the like may be added for improving selected properties as long as the objects of the invention are not compromised.

### Preparation of Epoxy Resin Composition

The epoxy resin composition of the invention is prepared as a molding compound by previously combining components (A) and (B), preferably components (A), (B) and (C), and uniformly melt mixing them at a temperature of 70 to 120° C., preferably 80 to 110° C. in a reactor such as a solventless system equipped with a heater, or by previously combining components (A), (B) and (D), preferably components (A), (B), (C) and (D), and uniformly melt mixing them at a temperature of 30 to 80° C., preferably 40 to 60° C. in a reactor such as a solventless system equipped with a heater. In the course of heating, the reaction mixture builds up its viscosity. The course continues until the mixture has a 3.0 softening point sufficient to handle at room temperature, specifically 50 to 100° C., preferably 60 to 90° C. The reaction mixture is then cooled whereupon it becomes solid.

The temperature range at which components are mixed is from 70° C. to 120° C., preferably from 80° C. to 110° C. when components (A) and (B), preferably components (A), (B) and (C) are combined together. Temperatures below 70° C. are too low to produce a mixture which becomes solid at room temperature. Temperatures above 120° C. provide too high a reaction rate, making it difficult to stop the reaction at the desired degree of reaction. The temperature range at which components (A), (B) and (D) or components (A), (B), (C) and (D) are mixed is from 30° C. to 80° C., preferably from 40° C. to 60° C. while the problems associated with lower or higher temperatures are the same as described above.

The solid reaction mixture is then ground and if necessary, combined with optional components (D), (E), (F) and (G) and other additives. This is intimately mixed on a mixer or the like, melt mixed on a hot roll mill, kneader or extruder, cooled for solidification again, and ground to a suitable size whereupon the ground material is ready for use as a molding compound of epoxy resin composition.

The epoxy resin composition thus obtained is advantageously used as encapsulants for semiconductor and electronic devices and equipment (excluding light emitting devices such as LED's but inclusive of photocouplers in which a light emitting devices and a photodetector are integrated), especially photocouplers. FIG. 1 is a cross-sectional view of a photocoupler as an exemplary semiconductor member encapsulated with the composition of the invention. The photocoupler shown in FIG. 1 includes a semiconductor member 1 of compound semiconductor which is die-bonded to a lead frame 2 and wire-bonded to another lead frame (not shown) via a bonding wire 3. A light-receiving semiconductor member 4, which is opposed to the semiconductor member 1, is die-bonded to a lead frame 5 and wire-bonded to another lead frame (not shown) via a bonding wire 6. A transparent sealant resin 7 fills in between the semiconductor members 1 and 4. The sealant resin 7 enclosing the semiconductor members 1 and 4 is encapsulated with the thermoset epoxy resin composition 8 of the invention.

The method of encapsulating the thermosetting epoxy resin composition over a semiconductor member(s) is most often low-pressure transfer molding. The epoxy resin composition of the invention is desirably molded at a temperature of 150 to 185° C. for 30 to 180 seconds and post-cured at a temperature of 150 to 185° C. for 2 to 20 hours.

### Example

Examples and Comparative Examples are given below for illustrating the invention although they should not be construed as limiting the invention.

The ingredients used herein are listed below.

### (A) Epoxy Resin

A-1: Triazine Derived Epoxy Resin
tris(2,3-epoxypropyl)isocyanate, TEPIC-S by Nissan Chemical Industries, Ltd., epoxy equivalent 100

A-2: Hydrogenated Epoxy Resin
hydrogenated bisphenol A epoxy resin, YL-7170 by Japan Epoxy Resin Co., Ltd., epoxy equivalent 1,200

A-3: Other Aromatic Epoxy Resin
bisphenol A epoxy resin, E1004 by Japan Epoxy Resin Co., Ltd., epoxy equivalent 890

### (B) Acid Anhydride

Carbon-to-carbon double bond-free acid anhydride:
methylhexahydrophthalic anhydride, Rikacid MH by New Japan Chemical Co., Ltd.

Carbon-to-carbon double bond-containing acid anhydride:
tetrahydrophthalic anhydride, Rikacid TH by New Japan Chemical Co., Ltd.

### (B') Curing Agent

phenol novolac resin, TD-2131 by Dainippon Ink & Chemicals, Inc.

### (C) Antioxidant

Phosphorus-Based Antioxidant:
triphenyl phosphite by Wako Pure Chemical Industries, Ltd.

Phenolic Antioxidant:
2,6-di-t-butyl-p-cresol, BHT by Wako Pure Chemical Industries, Ltd.

### (D) Curing Catalyst

Phosphorus-Based Curing Catalyst:
quaternary phosphonium bromide, U-CAT 5003 by San-Apro, Ltd.

Phosphorus-Based Curing Catalyst:
methyltributylphosphonium dimethylphosphite, PX-4 MP by Nippon Chemical Industrial Co., Ltd.

Imidazole Catalyst:
2-ethyl-4-methylimidazole, Curezol 2E4MZ by Shikoku Chemicals Corp.

### (E) Titanium Dioxide

rutile type, R-45M by Sakai Chemical Industry Co., Ltd.

### (F) Inorganic Filler

ground fused silica by Tatsumori Co., Ltd.

### Examples 1-4 and Comparative Examples 1 and 2

An epoxy resin composition was prepared by melt mixing reactive components selected from the components shown in Table 1 under the conditions shown in Table 1 to form a solid reaction product, grinding the solid reaction product, and compounding it with the remaining components.

Using a transfer molding machine, the epoxy resin composition was molded and cured at 170° C. for 90 seconds. Properties of the solid reaction product and the cured product were examined by the following tests. The results are also shown in Table 1.

### Solid Reaction Product

The solid reaction product was analyzed by gel permeation chromatography (GPC). A chromatograph HLC-8120 (Tosoh Corp.) equipped with TSK guard columns HXL-L+G4, 3, 2, 2H×L was used. Analysis conditions included a sample concentration 0.2 wt %, a feed volume 50 μl, a mobile phase THF 100%, a flow rate 1.0 ml/min, a temperature 40° C., and a detector RI.

From the GPC analysis data, the ratios of TEPIC-S monomer, MH monomer, moderate molecular weight fraction, and high molecular weight fraction were computed. The fraction ratio values in Table 1 are by weight.
TEPIC-S monomer: one area having a peak at 37.3±0.5 minutes
MH monomer: one area having a peak at 38.3±0.5 minutes
Moderate molecular weight fraction:
   area ranging from 30.8 to 36.8 minutes
High molecular weight fraction:
   area ranging from 0 to 30.8 minutes

### Evaluation of Composition

The composition was examined and evaluated for gel time, yellowing, heat resistance and strength.

### Gel Time:

A sample, 1.0 g, was placed on a hot plate at 175° C., at which point time measurement was started with a stopwatch.

The sample on the hot plate was scraped, detecting the time when the sample started gelation.

### Yellowing:

A sample, 10 g, was placed in an aluminum dish and cured at 180° C. for 60 seconds, after which it was examined for yellowing. The cured sample was held at 180° C. for 24 hours, after which it was examined for yellowing again.

Rating
⊚: clear, colorless
◯: pale yellow
Δ: light brown
X: brown

### TG-DTA:

Heat resistance was examined by thermogravimetric (TG)-differential thermal analysis (DTA). The composition was molded at 180° C. for 60 seconds into a disc specimen having a diameter of 10 mm and a height of 2 mm. It was heated at a rate of 5° C./min from room temperature to 500° C., obtaining a thermogravimetric curve. From the curve, the temperature corresponding to a weight loss of 0.2% was determined.

### Strength:

The composition was molded at 180° C. for 60 seconds into a specimen of 50×10×0.5 mm. Three-point flexural strength was measured at room temperature and a test speed of 2 mm/sec.

TABLE 1

| Component | Comparative | Example | Example | Example | Example | Comparative |
|---|---|---|---|---|---|---|
| (pbw) | Example 1 | 1 | 2 | 3 | 4 | Example 2 |

Pre-mixing

| | | | | | |
|---|---|---|---|---|---|
| TEPIC-S | 45 | 45 | 45 | 45 | 8 |
| E1004 | | | | | 67 |
| MH | 55 | 55 | 55 | 55 | 25 |
| Triphenyl phosphite | | 3 | 3 | | |
| 2E4MZ | | | | 1 | 1 |
| Molar ratio of epoxy/ | 1.4 | 1.4 | 1.4 | 1.4 | (1.0)* |
| acid anhydride in premix | | | | | 0.5 |
| Reaction conditions | 80° C./ | 80° C./ | 80° C./ | 40° C./ | 40° C/ |
| | 10 hr | 10 hr | 10 hr | 48 hr | 48 hr |

Post-mixing

| | | | | | | |
|---|---|---|---|---|---|---|
| TEPIC-S | 45 | | | | | |
| MH | 55 | | | | | |
| Triphenyl phosphite | 3 | 3 | | | 3 | 3 |
| 2E4MZ | 1 | 1 | 1 | | | |
| U-CAT5003 | | | | 2 | | |

GPC data of solid reaction product

| | | | | | | |
|---|---|---|---|---|---|---|
| MH monomer | 32.1 | 9.5 | 7.1 | 10.8 | 8.4 | 8.0 |
| TEPIC monomer | 53.7 | 16.5 | 13.3 | 16.4 | 19.0 | 2.2 |
| Moderate MW fraction | 3.0 | 16.2 | 17.3 | 16.3 | 45.4 | 58.3 |
| High MW fraction | 0 | 51.6 | 53.8 | 49.0 | 21.6 | 23.8 |

Cured properties

| | | | | | | |
|---|---|---|---|---|---|---|
| Gel time (sec) | 13 | 8 | 8 | 9 | 22 | 16 |
| Yellowing | | | | | | |
| as cured | Δ | ⊚ | ⊚ | ⊚ | ⊚ | ◯ |
| after 180° C./24 hr | X | ◯ | ⊚ | ⊚ | ◯ | Δ |
| TG-DTA | 270° C | 290° C | 295° C | 285° C. | 260° C. | 240° C. |
| Strength | 3.4 | 8.4 | 8.4 | 7.5 | 8.2 | 4.2 |

*The value in parentheses is a molar ratio of total epoxy groups to acid anhydride groups

It is noted that the solid reaction products of Examples 1 to 4 contain a compound having the formula (2) with a molecular weight of more than 1,500, a compound having the formula (2) with a molecular weight of 300-1,500, and the monomers in proportions X, Y, and Z (expressed by weight), respectively.

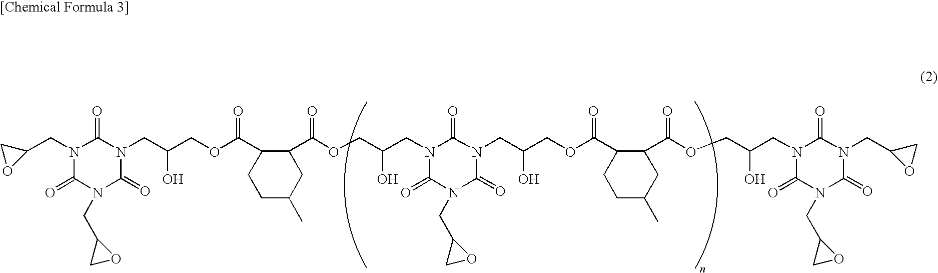

Solid reaction product of Example 1
X=51.6 Y=16.2 Z=27.0

Solid reaction product of Example 2
X=53.8 Y=17.3 Z=20.4

Solid reaction product of Example 3
X=49.0 Y=16.3 Z=27.2

Solid reaction product of Example 4
X=23.8 Y=58.3 Z=10.2

### Examples 5 and 6 and Comparative Examples 3-8

An epoxy resin composition was prepared by selecting the epoxy resin, acid anhydride and antioxidant from the components shown in Table 2, reacting them in a reactor at 100° C. for 3 hours to form a reaction product, cooling into a solid (having a softening point of 60° C.), grinding the solid reaction product, compounding it with the remaining components, and melt mixing the mixture on a hot two-roll mill until uniform, followed by cooling and grinding. The resulting epoxy resin composition was white and suited for the encapsulation of photocouplers.

These compositions were examined for several properties by the following tests, with the results shown in Table 2.

### [Spiral Flow]

The spiral flow was measured by molding the composition at 175° C. and 6.9 N/mm² for 120 seconds in a mold in accordance with EMMI standards.

### [Melt Viscosity]

The melt viscosity was measured at 175° C. under a load of 10 kgf with a constant-load orifice-type flow testing apparatus of the kind known in Japan as a Koka-type flow tester (orifice diameter 1 mm).

### [Flexural Strength]

A specimen was molded at 175° C. and 6.9 N/mm² for 120 seconds in a mold in accordance with EMMI standards before it was measured for flexural strength.

### [Heat Resistance/Yellowing]

A disc having a diameter of 50 mm and a height of 3 mm was molded at 175° C. and 6.9 N/mm² for 120 seconds and held at 180° C. for 24 hours, after which it was observed for yellowing.

TABLE 2

| | | | Example | | Comparative Example | | | | | |
|---|---|---|---|---|---|---|---|---|---|---|
| Formulation (pbw) | | | 5 | 6 | 3 | 4 | 5 | 6 | 7 | 8 |
| (A) | A-1 | TEPIC-S | 9 | 9 | 9 | | | | 4 | 14 |
| | A-2 | YL-7170 | | | | 20 | | | | |
| | A-3 | E1004 | | | | | 20 | 21 | | |
| (B) | Acid | MH | 14 | 14 | 14 | | 3 | | 17 | 9 |
| | anhydride | TH | | | | 3 | | | | |
| | Phenolic | TD-2131 | | | | | | 2 | | |
| | resin | | | | | | | | | |
| (C) | Antioxidant | triphenyl | 0.1 | 0.1 | 0.1 | 0.1 | 0.1 | 0.1 | 0.1 | 0.1 |
| | | phosphite | | | | | | | | |
| | | BHT | | 0.1 | | 0.1 | 0.1 | 0.1 | | |
| Reaction of | | | occurred | occurred | no | occurred | occurred | occurred | occurred | occurred |
| A + B + C components | | | | | | | | | | |
| (D) | Curing | PX-4MP | | 0.1 | | 0.1 | 0.1 | 0.1 | | |
| | catalyst | 2E4MZ | 0.1 | | 0.1 | | | | 0.1 | 0.1 |
| (E) | Titanium dioxide | | 6 | 6 | 6 | 6 | 6 | 6 | 6 | 6 |
| (F) | Inorganic filler | | 70 | 70 | 70 | 70 | 70 | 70 | 70 | 70 |
| Measured | Spiral flow | inch | 15 | 25 | 15 | 25 | 18 | 17 | 10 | 20 |
| results | Melt | Pa-s | 80 | 60 | 80 | 90 | 100 | 120 | 105 | 70 |
| | viscosity | | | | | | | | | |
| | Flexural | N/mm² | 100 | 110 | 80 | 60 | 90 | 160 | 110 | 80 |
| | strength | | | | | | | | | |
| | Yellowing | — | white | white | faint | yellow | yellow | pale | pale | pale |
| | | | | | yellow | | | yellow | yellow | yellow |

| | | | | | | | | |
|---|---|---|---|---|---|---|---|---|
| Molar ratio of epoxy/acid | 1.1 | 1.1 | (1.1)* | (1.0)* | (1.3)* | (1.3)* | 0.4 | 2.6 |
| anhydride in premix | | | | | | | | |

*The value in parentheses is a molar ratio of total epoxy groups to acid anhydride groups

1. A thermosetting epoxy resin composition comprising as a resin component a solid reaction product obtained through reaction of a triazine derived epoxy resin with an acid anhydride in an epoxy group equivalent to acid anhydride group equivalent ratio of 0.6 to 2.0, the solid reaction product being ground.

2. The epoxy resin composition of claim 1 wherein the triazine derived epoxy resin is a 1,3,5-triazine nucleus derived epoxy resin.

3. The epoxy resin composition of claim 2 wherein the solid reaction product comprises a compound having the general formula (1): 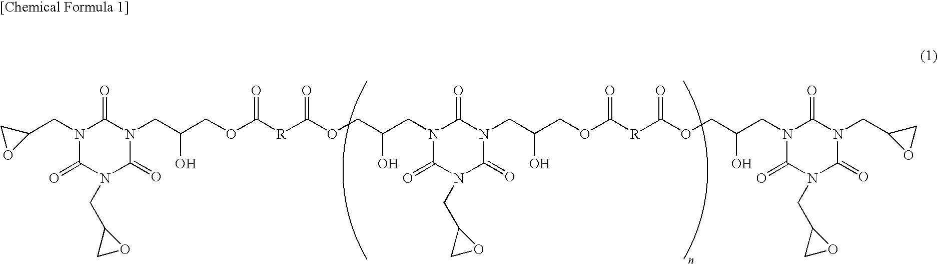
wherein R is an acid anhydride residue and n is a number of 0 to 200.

4. The epoxy resin composition of claim 1, 2 or 3 wherein the acid anhydride is non-aromatic and free of a carbon-to-carbon double bond.

5. The epoxy resin composition of any one of claims 1 to 4 wherein the reaction of a triazine derived epoxy resin with an acid anhydride is carried out in the presence of an antioxidant.

6. The epoxy resin composition of claim 5 wherein the antioxidant is selected from the group consisting of phenolic, phosphorus-based and sulfur-based antioxidants, and mixtures thereof.

7. The epoxy resin composition of claim 6 wherein the antioxidant comprises triphenyl phosphite and/or 2,6-di-t-butyl-p-cresol.

8. The epoxy resin composition of any one of claims 1 to 7 wherein the reaction of a triazine derived epoxy resin with an acid anhydride is carried out at a temperature of 70 to 120° C.

9. The epoxy resin composition of any one of claims 1 to 7 wherein the reaction of a triazine derived epoxy resin with an acid anhydride is carried out in the presence of a curing catalyst.

10. The epoxy resin composition of claim 9 wherein the curing catalyst is 2-ethyl-4-methylimidazole.

11. The epoxy resin composition of claim 9 wherein the curing catalyst is methyltributylphosphonium dimethylphosphite or a quaternary phosphonium bromide.

12. The epoxy resin composition of claim 9, 10 or 11 wherein the reaction of a triazine derived epoxy resin with an acid anhydride is carried out at a temperature of 30 to 80° C.

13. The epoxy resin composition of any one of claims 1 to 12, further comprising titanium dioxide.

14. The epoxy resin composition of any one of claims 1 to 13, further comprising an inorganic filler other than titanium dioxide.

15. The epoxy resin composition of any one of claims 1 to 12, which is transparent.

16. The epoxy resin composition of any one of claims 1 to 15, which is used to form a casing for semiconductor members excluding light emitting members.

17. A semiconductor device comprising a semiconductor member excluding light emitting members, which is encapsulated with the epoxy resin composition of any one of claims 1 to 15 in the cured state.
